(19) United States
(12) Patent Application Publication
(10) Pub. No.: US 2023/0004634 A1
(43) Pub. Date: Jan. 5, 2023

(54) MANAGEMENT SYSTEM, DEVICE, DEVICE MANAGEMENT METHOD, CONTROLLING METHOD, AND NON-TRANSITORY COMPUTER-READABLE RECORDING MEDIUM THEREFOR

(71) Applicant: BROTHER KOGYO KABUSHIKI KAISHA, Nagoya (JP)

(72) Inventor: Eriko TAKAHASHI, Nagoya (JP)

(73) Assignee: BROTHER KOGYO KABUSHIKI KAISHA, Nagoya (JP)

(21) Appl. No.: 17/849,309

(22) Filed: Jun. 24, 2022

(30) Foreign Application Priority Data
Jun. 30, 2021 (JP) 2021-108827

(51) Int. Cl. G06F 21/44; G06F 21/34

(52) U.S. Cl. CPC G06F 21/44; G06F 21/34

(57) ABSTRACT

A management system includes a device and a management device. The device receives user information and transmits the user information device information to the management device. The management device receives the user information and the device information transmitted from the device and transmits one of device-related data and location information to an information processing device. The device-related data includes data used to control the device indicated by the device information received from the information processing device. The location information indicates a location of the device-related data.

### REFERENCE TO RELATED APPLICATIONS

This application claims priority under 35 U.S.C. § 119 from Japanese Patent Application No. 2021-108827 filed on Jun. 30, 2021. The entire subject matter of the application is incorporated herein by reference.

### BACKGROUND ART

The present disclosures relate to a management system, a device, a device management method, a controlling method, and a non-transitory computer-readable recording medium for controlling a device.

There has been known a method to change a printer driver in each of a plurality of client devices from a management device. According to the conventional method, a client device, which is a transmission destination of the data for changing the printer driver, is selected by the management device.

### DESCRIPTION

In order to realize the conventional method described above, it is necessary for an administrator to create and manage information that links the printer to be controlled by the printer driver and a client device that uses the printer in advance in the management device. This increases the burden of management by the administrator. Such problems can arise when managing not only printers but also various other devices and information processors that use the printers and other devices.

According to aspects of the present disclosure, there is provided a management system including a device and a management device. The device includes a first communication interface configured to communicate with a portable communication device, the management device and an information processing device, and a first controller. The first controller can perform first receiving of user information for identifying a user from the portable communication device through the first communication interface, and first transmitting of the user information received in the first receiving and device information for identifying the device to the management device through the first communication interface. The management device includes a second communication interface configured to communicate with the device and the information processing device, and a second controller. The second controller can perform second receiving of the user information and the device information transmitted in the first transmitting through the second communication interface, and second transmitting of one of device-related data and location information to the information processing device corresponding to the user information received in the second receiving, the device-related data including data used to control, from the information processing device, the device indicated by the device information received in the second receiving, the location information indicating a location of the device-related data.

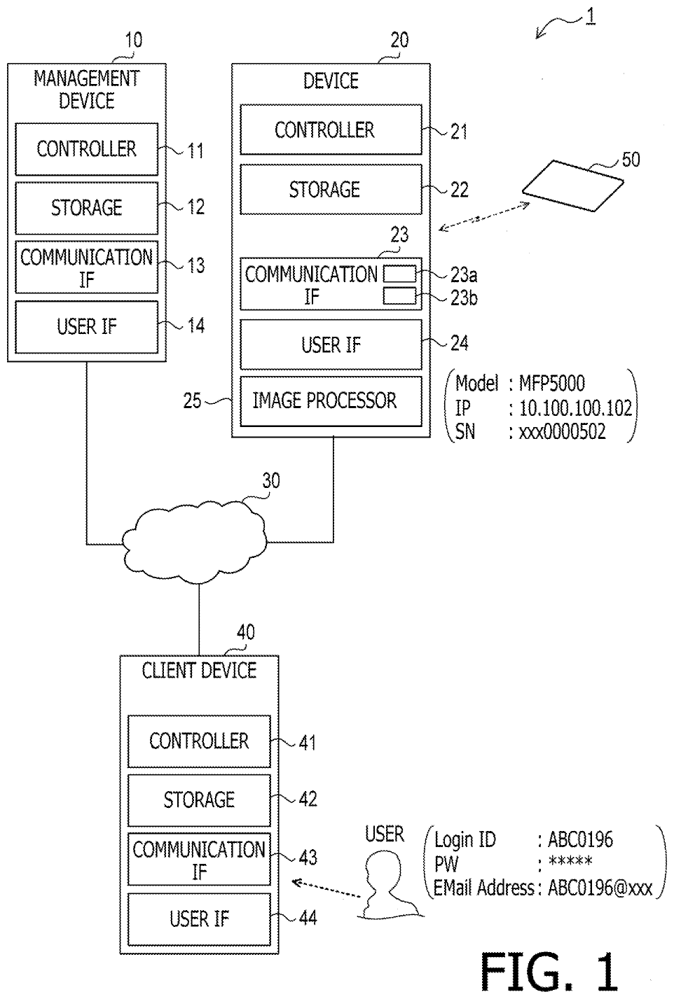

FIG. 1 is a block diagram of a device management system.

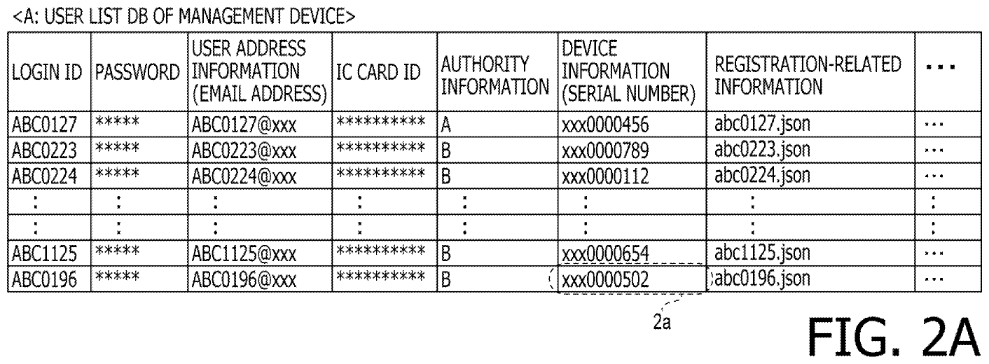

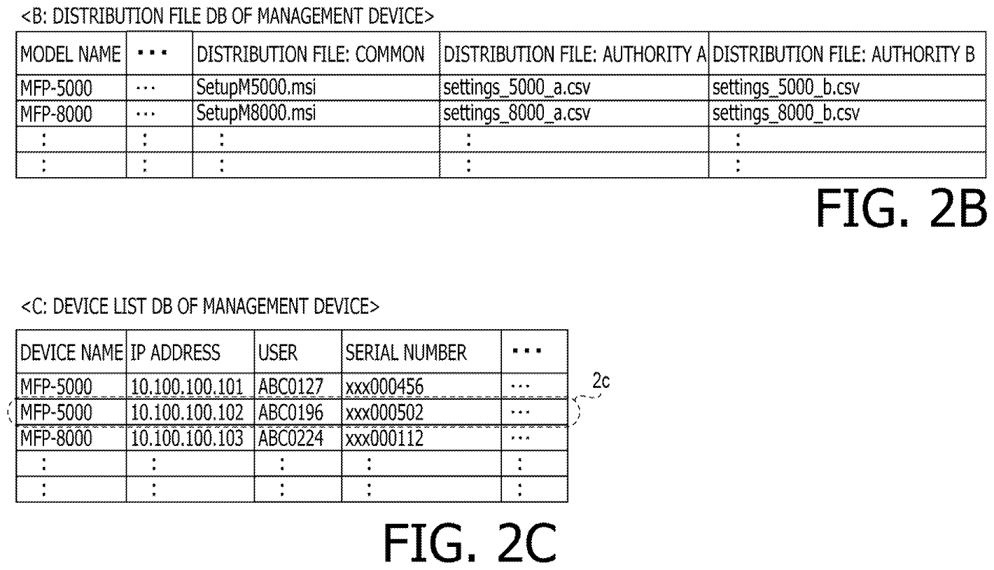

FIG. 2A shows a data structure of a list database.

FIG. 2B shows a data structure of a distribution file management database.

FIG. 2C shows a data structure of a device list database.

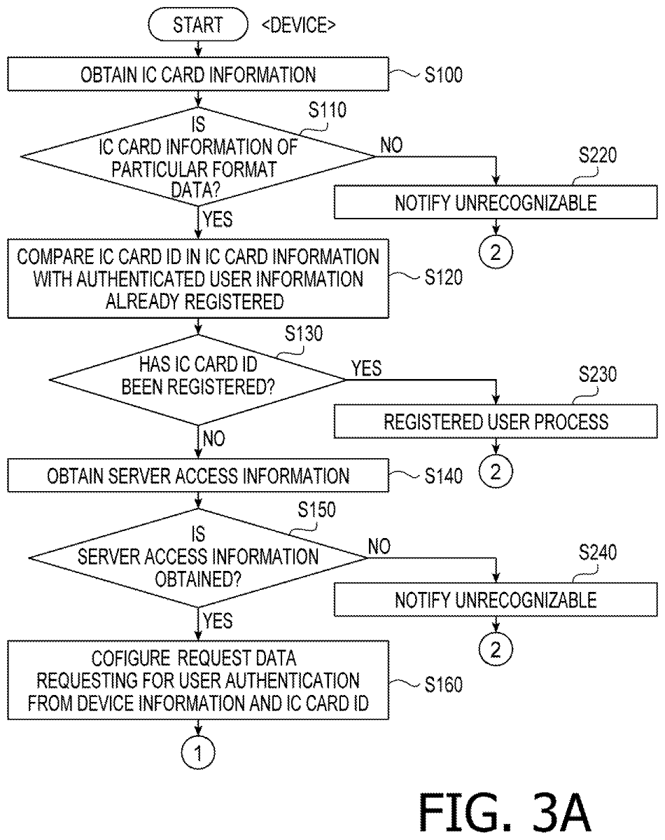

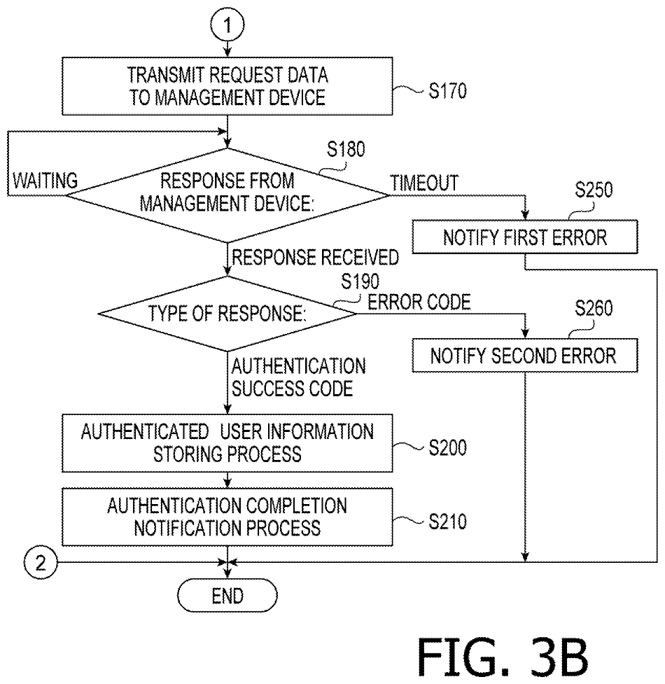

FIGS. 3A-3B show a flowchart illustrating a user communication handling process performed in a device.

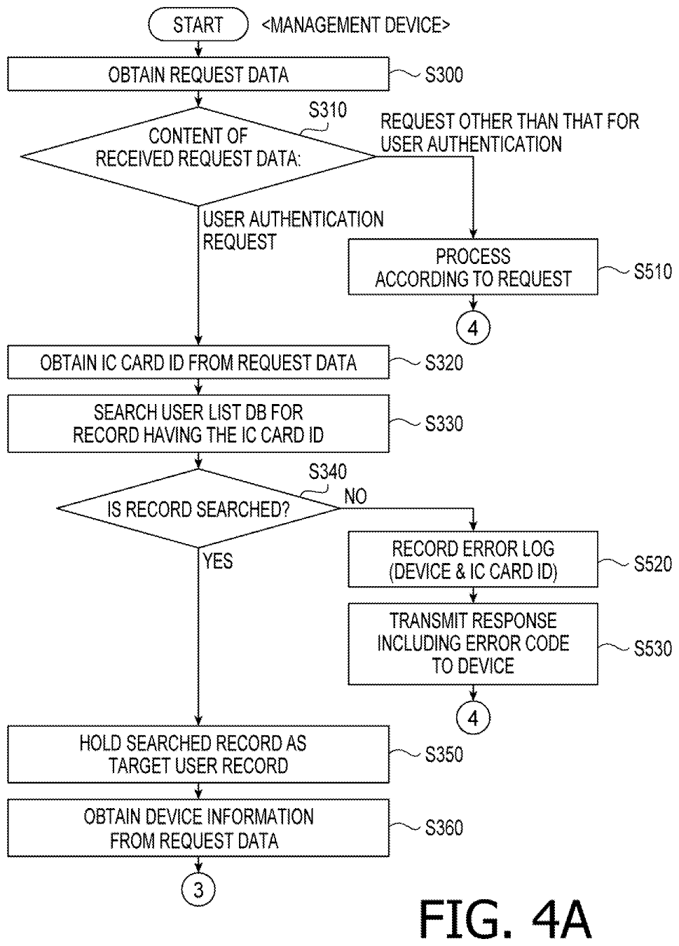

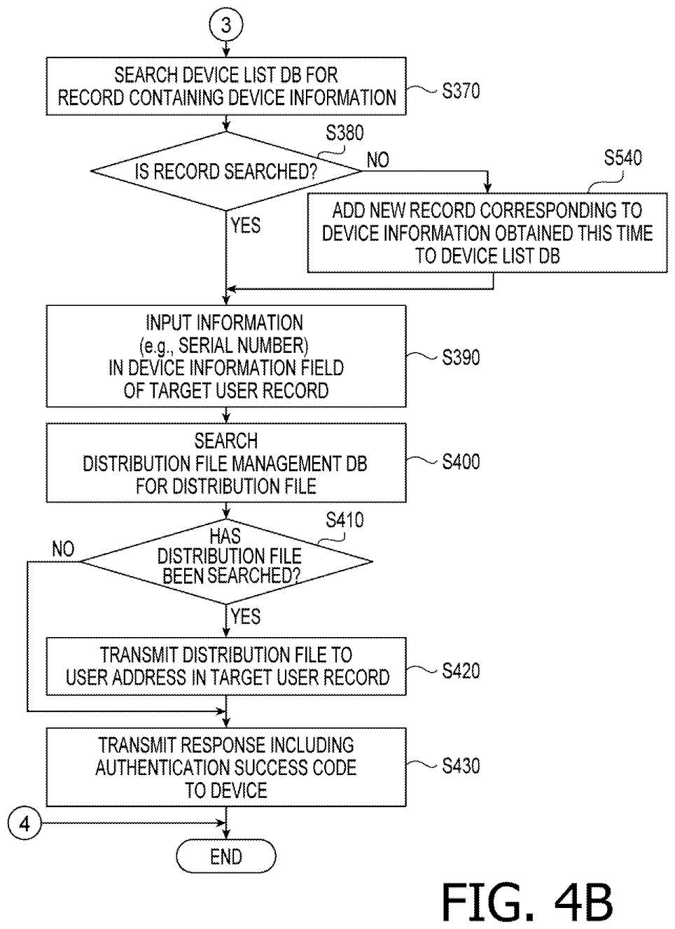

FIGS. 4A-4B show a flowchart illustrating a file-providing process performed by a management device.

Hereinafter, referring to the accompanying drawings, an embodiment according to the present disclosures will be described.

### 1. EMBODIMENT

### 1-1. Overview of Device Management System

As shown in FIG. 1, a device management system 1 includes a management device 10, a device 20, a client device 40, which are connected to a network 30 and communicatively interconnected via the network 30.

The device 20 is communicable with a portable communication device 50. The portable communication device 50 is, for example, an IC card. In the following description, the portable communication device 50 will be referred to as an “IC card 50.”

The device management system 1 may include one or more devices besides the device 20. Further, the device management system 1 may include one or more client devices besides the client device 40.

The network 30 may include at least one of a WAN (wide area network) and a LAN (local area network). The network 30 may include, for example, a LAN connecting the client device 40 and the device 20, and a WAN connecting the LAN above and the management device 10. The WAN may include the Internet. The LAN may include, for example, at least one of a wireless LAN and a wired LAN.

The device 20 is configured as a so-called peripheral device of the client device 40 and is communicatively connected to the client device 40. The device 20 may include various functions. According to the present embodiment, the device 20 has an image processing function. Concretely, the device 20 according to the embodiment has a printing function and a scanning function. The printing function is a function of obtaining image data, and printing an image represented by the image data on a printing medium. The scanning function is a function of scanning an image and generating scan data representing the scanned image.

In the device management system 1, the management device 10 is configured to manage one or more devices including the device 20 and one or more client devices including the client device 40. For example, the management device 10 manages, for each client device, users who can use (e.g., log in) the client device and the devices that the users can use. The administrator can manage each device and each client device by accessing a management site at the management device 10 using, for example, a Web browser.

The management device 10 and the client device 40 are each constructed, for example, by installing a computer program to realize the desired function in an information processing device (e.g., a general-purpose personal computer). The management device 10 and client device 40 may each be, for example, a stationary information processing device, or a portable information processing device, which can be easily carried around, such as a smartphone or tablet terminal.

Each user is given an IC card. The management device 10 sends a distribution file or location information to the client device used by the user in response to a request from the device originating from communication between the IC card held by the user and the device. The distribution file contains data used to use (e.g., control) the device from the client device used by the user concerned. More concretely, the distribution file may include, for example, device drivers, configuration files, and various other application software. The location information indicates the location of the distribution file.

The IC card 50 shown in FIG. 1 is, as an example, an IC card given to a user who can use the client device 40. The following description assumes, as an example, that a user of the client device 40 is attempting to use the device 20 from the client device 40.

In the IC card 50, IC card information is stored. The IC card information includes information that can identify the user of the 50 IC cards. In this embodiment, the IC card information includes an IC card ID. The IC card ID is a unique user identifier.

The IC card information may include, for example, server access information. The server access information is information for device 20 to access (e.g., connect) to the management device 10. The server access information may include, for example, the IP address or URL of the management device 10.

### 1-2. Configuration of Device

The device 20 has a controller 21, a storage 22, a communication IF 23, a user IF 24, and an image processor 25, as shown in FIG. 1. “IF” is an abbreviation for “interface.” The image processor 25 performs the aforementioned printing and scanning functions under the control of the controller 21.

The controller 21 has, for example, a CPU. The storage 22 includes a semiconductor memory such as a ROM, a RAM, an NVRAM, and a flash memory. In other words, the device 20 is provided with a microcomputer including the CPU and the semiconductor memory.

The controller 21 realizes various functions by executing programs stored in the storage 22. In the present embodiment, the storage 22 serves as a non-transitory computer-readable storage medium storing the programs. It should be noted that the various functions realized by the controller 21 are not necessarily realized by execution of the programs, but a part of or all of the functions may be realized by one or more hardware.

The storage 22 is configured to store various programs and data. As will be described later, in the storage, a program for a user communication handling process shown in FIGS. 3A-3B is stored. The storage 22 may be provided with a memory different from the semiconductor memory (e.g., a hard disk drive).

In the storage 22, device information is also stored. The device information is information for distinguishing or identifying the device 20. In this embodiment, the device information includes, for example, a model name, an IP address, and a serial number. The model name of the device 20 is, for example, “MFP-5000.” The IP address of the device 20 is, for example, “10.10.0.100.102.” The serial number of the device 20 is, for example, “xxx0000502.”

The communication IF 23 is an interface for communicating with communication devices external to device 20. The communication IF 23 in this form is equipped with a first communication IF 23a and a second communication IF 23b. The first communication IF 23a is configured to communicate directly, on a one-to-one basis, with the destination communication device. Concretely, the first communication IF 23a performs wireless communication using, for example, a wireless communication method based on a communication standard for short-range wireless communication. The communication standard for the short-range wireless communication is, for example, Near Field Communication (NFC).

According to the present embodiment, the IC card 50 is configured to perform wireless communication using the same wireless communication method as the first communication IF 23a employs. Therefore, when the IC card 50 is held over the device 20, the IC card 50 and the first communication IF 23a communicate wirelessly with each other using the short-range wireless communication method. It should be noted that holding the IC card 50 over the device 20 means bringing the IC card 50 into proximity or contact with the device 20 so that the IC card 50 and the first communication IF 23a are in a distance and/or positional relationship that enables the short-range wireless communication with each other.

The second communication IF 23b is an interface for connecting the device 20 to the network 30. The device 20 can communicate with various communication devices connected to network 30, including the management device 10 and the client device 40, via the second communication IF 23b.

The user IF 24 is an interface for receiving various input operations by the user and providing various types of information to the user. The user IF 24 can provide various types of information to the user, for example, by means of images and/or sound. The user IF 24 may include, for example, a display and a touch panel on the display.

### 1-3. Configuration of Management Device

As shown in FIG. 1, the management device 10 has a controller 11, a storage 12, a communication IF 13, and a user IF 14.

The controller 11 has, for example, a CPU. The storage 12 has a semiconductor memory such as a ROM, a RAM, an NVRAM, and a flash memory, for example. In other words, the management device 10 is equipped with a microcomputer that includes the CPU and the semiconductor memory.

The controller 11 realizes the various functions of the management device 10 by executing programs stored in the storage 12. According to the present embodiment, the storage 12 is a non-transitory computer-readable storage medium. It should be noted that the various functions realized by the controller 11 are not necessarily limited to ones realized by execution of the programs, but a part of or all of the functions may be realized by one or more pieces of hardware.

Various programs and data are stored in the storage 12. In particular, a program for a file-providing process (see FIGS. 4A-4B) is stored in the storage 12. Further, a user list database (see FIG. 2A), a distribution file management database (see FIG. 2B) and a device list database (see FIG. 2C) are also stored in the storage 12.

The user list database shown in FIG. 2A includes registration information for each user registered with the device management system 1. Concretely, in the user list database, a login ID, a password, user address information, IC card ID, authority information, device information and registration-related information are registered for each user.

The login ID and the password are used to log in to the device management system (i.e., to log in to a client device of the user). The user address information indicates an address of a transmission destination when various data is to be transmitted to the user. According to the present embodiment, the user address information is an email address of the user. It is noted that the user address information may be information indicating an address of the client device 40 that the user uses. The IC card ID is a card ID of an IC card held by the user. The authority information is information indicating authorization given to the user. The device information is information with which a device the user can use (e.g., a device that the user used in the past). In the present embodiment, a serial number of the device is used as the device information, for example. The registration-related information is information particular information related to the user. As will be described, the registration-related information may be transmitted to the device the user uses. The registration-related information may include a part of or all of the registered information of the user in the user list database. The registration-related information may include, for example, extended function information associated with the user (e.g., an address book), function restriction information (e.g., restriction of the number of copies), template data dedicated for the user, and the like.

According to the present embodiment, a lowermost record in FIG. 2A is the registration information of the user of the client device 40. In this example, the login ID of the user is “ABC0196” and the user address information is “ABC0196@xxx.”

The distribution file management database shown in FIG. 2B indicates, for each device model, a distribution file that should be distributed (i.e., transmitted) to a client device that uses the device to be installed or retained. The distribution files include common distribution files that are distributed regardless of the authority of the user using the device and individual distribution files prepared separately for each authority. FIG. 2B shows an example where an MSI file is prepared for each model as a common distribution file and a CSV file as an individual distribution file for each authority. The administrator may set up a distribution file for each device model, as needed, that should be installed or retained on the client device for using that model from the client device.

The device list database shown in FIG. 2C shows, for each authenticated user, information on the device used by that user at the time of the authentication. The storage 12 may have a device such as a hard disk drive which is different from the semiconductor memory.

The communication IF 13 is an interface configured to connect the management device 10 to the network 30. The management device 10 is configured to communicate with various communication devices, including the device 20 and the client device 40, connected to the network 30 via the communication IF 13.

The user IF 14 is an interface configured to receive various input operations by the administrator and for providing various information to the administrator. The user IF 14 is configured to provide various types of information to the administrator with the use of images and/or audio. The user IF 14 may have, for example, a display, a touch panel on the display, a keyboard, a mouse, and the like.

### 1-4. Configuration of Client Device

The client device 40 has, as shown in FIG. 1, a controller 41, a storage 42, a communication IF 43, and a user IF 44.

The controller 41 has a CPU. The storage 42 includes semiconductor memories such as a ROM, a RAM, an NVRAM, a flash memory. That is, the client device 40 is provided with a microcomputer equipped with the CPU and the semiconductor memories.

The controller 41 realizes various functions by executing programs stored in the storage 42. According to the present embodiment, the storage 42 is a non-transitory computer-readable storage medium. It is noted that the functions realized by the controller 41 are not necessarily limited to one realized by execution of a program, but may be realized by one or more pieces of hardware.

Various programs and data are stored in the storage 42. Further, software for transmitting and receiving emails (i.e., a mailer) is installed in the storage 42. The storage 42 may include memories such as a hard disk drive, which are different from the semiconductor memory.

Further, distribution files which are transmitted from the management device 10 may be stored in the storage 42. For example, if the user sets an account of the email address of the user in the mailer of the client device 40, when distribution files are transmitted from the management device 10 to the email address, the user can receive the distribution file with the client device 40. Then, using the received distribution file, the user can use the device 20 from the client device 40.

It is noted that, when a device driver required for use of the device 20 has not yet been installed on the client device 40, if a distribution file containing the device driver is received, by installing that device driver on the client device 40, the device 20 can be used from the client device 40.

If the administrator wishes to impose functional restrictions on the use of device 20 by users with authority B, including users of client device 40, by setting configuration data indicating the contents of such functional restrictions as the distribution file for authority B of the device 20 (e.g., MPF-5000 in the present implementation), the administrator can impose such functional restrictions. That is, when such configuration data is sent to and applied to the client device of a user with authority B, the functions available to the user of that client device are restricted when using the device 20.

The communication IF 43 is an interface configured to connect the client device 40 to the network 30. The client device 40 is configured to communicate with various communication devices, including the device 20 and the management device 10, connected to the network 30 via the communication IF 43.

The user IF 44 is an interface configured to receive various input operations by the user and provide various types of information to the user. The user IF 44 is configured to provide various types of information to the user with the use of images and/or audio. The user IF 44 may have, for example, a display, a touchscreen panel on the display, a keyboard, a mouse, and the like.

### 1-5. User Communication Handling Process in Device

A user communication handling process performed by the controller 21 of the device 20 will be described with reference to FIGS. 3A-3B. The controller 21 starts the user communication handling process in response to the IC card 50 being held over the device 20. That is, the controller 21 starts the user communication handling process (FIGS. 3A-3B) in response to receiving IC card information via the first communication IF 23a from the IC card 50 that is held over the device 20. In the following description, the processes performed between the management device 10, the device 20, and these processes are performed through communications via the network 30 using the respective communication IFs of the corresponding devices, as described in detail below.

When starting the user communication handling process, the controller 21 obtains the IC card information (S110), which is received from the IC card 50. The controller 21 determines (S120) whether the obtained IC card information is of particular format data. The particular format is a format having been defined in advance. The particular format may include data of a table type format with particular contents. More concretely, the particular format includes a CSV format or a Jason format. In other words, particular format data may be data having a file name of which extension is CSV or JSON. When the obtained IC card information is not the particular format data, the controller 21 proceeds to S220. In S220, the controller 21 informs the user that the obtained IC card information cannot be recognized, for example, via the user IF 24 of the device 20. Concretely, the controller 21 may, for example, display information on the user IF 24 to the effect that “authentication was failed.”

When it is determined that the obtained IC card information is of the particular format (S110: YES), the controller 21 executes S120. In S120, the controller 21 compares the IC card ID contained in the obtained IC card information with the authenticated user information already registered with the device 20. Concretely, it is checked whether the IC card ID obtained at this time is already included in the registered authenticated user information or not. It is noted that the authenticated user information is registered, for example, in S200 described later.

In S130, the controller 21 determines whether the IC card ID obtained this time has already been registered with the device 20 based on the processing result in S120. When the IC card ID has already been registered with the device 20 (S130: YES), the controller 21 proceeds to S230. In S230, the controller 21 starts a registered user process. Concretely, for example, the controller 21 executes a particular process which is determined to be performed when the registered IC card ID is obtained. That is, when the obtained IC card ID has already been registered, other processes corresponding to the IC card ID are executed without executing any process in S140 onward (i.e., avoiding the transmission of request data in S170, which will be described later). It is noted that the user communication handling process may be simply terminated without executing the process in S230. After the execution of S230, the controller 21 terminates the user communication handling process.

When it is determined that the IC card ID obtained this time has not yet been registered with the device 20 (S130: NO), the controller 21 proceeds to S140. In S140, the controller 21 obtains server access information. In the present embodiment, the server access information is stored in the storage 22 of the device 20. Therefore, in S140, the controller 21 obtains the server access information from the storage 22.

In S150, the controller 21 determines whether the server access information is obtained. When the server access information is not obtained (S150: NO), the controller 21 proceeds to S240. In S240, the controller 21 informs the user that authentication by the IC card is not possible. After execution of S240, the controller 21 terminates the user communication handling process.

When the server access information is obtained (S150: YES), the controller 21 proceeds to S160. In S160, the controller 21 configures the request data from the device information and the obtained IC card ID. The request data is data to request the management device 10 for user authentication. The request data includes some or all of the device information and the IC card ID. That is, the device information included in the request data may be a part of all device information, including the aforementioned model names, IP addresses and serial numbers.

In S170, the controller 21 accesses the management device 10 based on the server access information obtained in S140. Then, the request data configured in S160 is transmitted to the management device 10.

In S180, the controller 21 determines whether a response to the request data is received from the management device 10. It is noted that the management device 10 is configured to transmit the response in S430 in FIGS. 4A-4B, which will be described later.

After transmitting the request data in S170, when a specified time has elapsed (i.e., time-out) without a response being received, the controller 21 performs a first error notification in S250. The first error notification is a process to inform the user that communication with the management device 10 was not performed normally. After executing S250, the controller 21 terminates the user communication handling process.

When the response from the management device 10 is received (S180: Response Received), the controller 21 proceeds to S190. The controller 21 determines a type of the response received at S190. In the present embodiment, the response types include, for example, an authentication success code and an error code, and a response including one of the same is transmitted from the management device 10.

When an error code is included in the received response (S190: Error Code), the controller 21 proceeds to S260. In S260, the controller 21 performs a second error notification. The second error notification is a process to notify the user that the user is not registered with the management device 10. After the execution of S260, the controller 21 terminates the user communication handling process.

When the received response includes an authentication success code (S190: Authentication Success Code), the controller 21 proceeds to S200. Concretely, the controller 21 registers particular information, including the IC card ID transmitted to the management device 10, with the device 20 as authenticated user information. The fact that authenticated user information is registered with the device 20 means that the corresponding user has been registered in the user list database (see FIG. 2A) of the management device 10.

The controller 21 executes the authentication completion notification process in S210. Concretely, the controller 21 notifies via the user IF 24 that the registration of the user of the IC card 50 to the management device 10 has been completed. After the execution of S210, the controller 21 terminates the user communication handling process.

### 1-6. File-Providing Process in Management Device

The file-providing process to be executed by the controller 11 of the management device 10 is described with reference to FIGS. 4A-4B. When the controller 11 receives the request data from the device 20 via the communication IF 13, the controller 11 starts the file-providing process.

When the controller 11 starts the file-providing process, the controller 11 obtains the received request data in S300. The device 20 may also transmit request data indicating a different request from the request for user authentication.

In S310, the controller 11 determines whether the received request data is a request for user acknowledgement or a request for something other than a request for user authentication. When the received request data is a request for something other than a request for user authentication, the controller 11 proceeds to S510. In S510, the controller 11 executes a process according to the contents of the request indicated by the received request data. After execution of S510, the controller 11 terminates the file-providing process.

When the received request data is for requesting the user authentication (S310: User Authentication), the controller 11 proceeds to S320. In S320, the controller 11 obtains the IC card ID from the received request data.

The controller 21 searches for a record containing the IC card ID obtained in S320 by referring to the user list database (FIG. 2A) in S330. For the convenience of explanation, it is assumed that, in the user list database, basic information of the user of the IC card 50 (that is, the user of the client device 40), is registered in the record in the lowermost row of FIG. 2A, but the device information shown by a broken line 2a in the record has not yet been registered at this point. It is further assumed that, in the device list database shown in FIG. 2C, a record indicated by a broken line 2c has not yet been registered.

In S340, the controller 11 determines whether the record of the user is searched in S330. When the record of the user has not been searched for (S340: NO), the controller 11 proceeds to S520. In S520, the controller 11 records an error log. Concretely, the controller 11 records the fact that request data was received from an unregistered user (i.e., unregistered IC card ID), together with the device information and the IC card ID in the request data as an error log. The administrator can check this error log.

In S530, the controller 11 transmits a response including an error code to the device 20. When the response containing this error code is received by device 20, the device 20 performs the process of S260 described above.

When it is determined that the record of the user is searched (S340: YES), the controller 11 proceeds to S350. In S350, the controller 11 holds the searched record (in this example, the record in the lowermost row in FIG. 2A) as a target user record. The controller 11 obtains the device information from the request data in S360.

In S370, the controller 11 searches the device list database (FIG. 2C) for records containing the device information obtained in S360. When the relevant record is searched, the process proceeds to S390. When no relevant record is searched, the process proceeds to S540. According to the present embodiment, it is assumed, at this stage, that the record (indicated by the broken line 2c) has not been registered, the controller 11 proceeds to S540.

In S540, the controller 11 adds a new record corresponding to the device information obtained this time to the device list database. That is, as shown by the broken line 2c in FIG. 2c, a new record is added, in which the device information obtained this time and the user corresponding to the IC card ID obtained this time are associated with each other.

In S390, the controller 11 inputs information on the device in a device information field in the target user record. Concretely, for example, in the present embodiment, a serial number of the device is entered, as shown by the broken line 2a in FIG. 2A.

In S400, the controller 11 searches the distribution file management database (FIG. 2B) for the distribution file corresponding to the device model. Concretely, the controller 11 searches for a common distribution file that is unrelated to the user's authority and a distribution file that corresponds to the user's authority. In the present embodiment, since the model name of device 20 is “MFP-5000,” the record on the top line of the distribution file management database is referred to, and the common distribution file in that record (e.g., “SetupM5000.msi”) is searched. It is noted that this common distribution file is, for example, a device driver for the device 20. In addition, since the authority of the user of the IC card 50 is authority B, a file (e.g., “settings_5000_b.csv”) corresponding to authority B in the record is searched.

The controller 11 determines, in S410, whether the distribution file has been searched in S400. When it is determined, in S410, that no distribution file has been searched, it means that there is no distribution file that should be sent to the client device 40, at least at this time. Therefore, in this case, the controller 11 proceeds to S430.

When it is determined, in S410, that the distribution file has been searched, the controller 11 proceeds to S420. In S420, the distribution file searched in S400 is transmitted to the address (e.g., “ABC0196@xxx”) which is indicated in the user address information in the target user record. In other words, the distribution file is transmitted to the address of the user of the IC card 50 that is held over the device 20.

Since the distribution file is sent to the user's address in this way, the user can receive the distribution file on the client device 40, and the user can install or retain the distribution file. In this way, the user can use the device 20 from the client device 40 using the distribution file.

The controller 11 transmits a response including the authentication success code to the device 20 in S430. When the response containing this authentication success code is received by the device 20, the device 20 executes the process of S200 described above. After execution of S430, the controller 11 terminates the file-providing process.

### 1-7. Effects of First Embodiment

According to the first embodiment, the following effects (1a)-(1e) are achieved.

(1a) In the device management system 1 according to the present embodiment, when the user holds the IC card 50 over the device 20 and provides the IC card information to the device 20, a distribution file for using the device 20 from the client device 40 is provided to the client device 40 (e.g., to the user's address). Therefore, the client device 40 can obtain the file for using (e.g., controlling) the device 20 easily.

Use cases of the device management system 1 in this embodiment will be presented here by way of example. That is, for example, a manager of a company gives telecommuters who work at home from among the company's employees the device 20 to use when they work at home. The telecommuters have the IC cards 50, respectively. When the telecommuter receives the device 20 at home, he or she holds the IC card 50 over the device 20. In this way, a distribution file is sent to the telecommuter's address for using the device 20 from the telecommuter's client device 40. The telecommuter receives the distribution file on client device 40 and installs or retains the file as needed. In this way, the telecommuter can use the device 20 from the client device 40 at home.

In such a usage situation, the telecommuter can obtain the necessary distribution file simply by holding the IC card 50 over the device 20. The administrator does not necessarily need to strictly manage the device 20 at the time when the device 20 is provided to the telecommuter. As for who is to use the provided device 20, it is registered in the management device 10 in the file-providing process in FIGS. 4A-4B (see FIG. 2A and FIG. 2C). That is, there is no need for the administrator to register the device 20 and the telecommuter in an associated manner in the management device 10. Therefore, after providing a device 20 to a telecommuter, the administrator can check who actually came to use the device 20 through the various databases of the management device 10 retroactively.

(1b) The controller 21 of the device 20 obtains server access information in S140 of the user communication handling process shown in FIG. 2. Therefore, the controller 21 can transmit, in S170, the request data to the management device 10 easily based on the obtained server access information.

(1c) According to the present embodiment, the server access information is stored in the storage 22 of the device 20. Therefore, the controller 21 can easily obtain the server access information from the storage 22 in S140. In addition, since it is not necessary to provide the server access information from the IC card 50 to the device 20, the configuration of the IC card 50 can be simplified.

(1d) In the present embodiment, the controller 21 of the device 20 performs the user communication handling process shown in FIGS. 3A-3B in response to the IC card 50 being held over to the device 20. In other words, transmission of the request data from the device 20 to the management device 10 (S170) is performed in response to receipt of the IC card information from the IC card 50. Therefore, the IC card ID and device information can be quickly sent to the management device 10, which in turn allows the client device 40 to quickly obtain the distribution file.

(1e) When the controller 21 of the device 20 receives a response containing an authentication success code in response to the request data sent to the management device 10, the controller 21 stores the authenticated user information including the IC card ID sent to the management device 10 in the storage 22 (S200). Then, when the same IC card ID is received again thereafter, the process is shifted from S130 to S230 to avoid execution of S140 and subsequent processes.

Therefore, in the client device 40, the distribution file that has already been acquired can be suppressed from being received again. That is, it is possible to provide distribution files to each user without excess or deficiency.

In this embodiment, the client device 40 corresponds to an example of an information processing device according to the present disclosures. The IC card ID corresponds to an example of user information according to the present disclosures. The distribution file sent from the management device 10 to the client device 40 in S420 corresponds to an example of device-related data according to the present disclosures.

The process of S100 corresponds to an example of a first receiving process and a receiving process by a device according to the present disclosures. The process in S140 corresponds to an example of an obtaining process according to the present disclosures. The process of S170 corresponds to an example of a first transmission process and a transmission process by the device according to the present disclosures. The process of S200 corresponds to an example of a storage process according to the present disclosures. The process of S300 corresponds to an example of a second receiving process and a receiving process by the management device according to the present disclosures. The process of S420 corresponds to an example of a second transmission process and a transmission process by the management device according to the present disclosures.

### 2. OTHER EMBODIMENTS

Although an embodiment of the present disclosure is described above, the present disclosures are not necessarily limited to the embodiment described above, but can be modified and implemented in various ways.

2-1. The controller 21 of the device may obtain the server access information by any means in S140 of the user communication handling process shown in FIGS. 3A-3B. For example, when the IC card information obtained from the IC card 50 contains the server access information, the controller 21 may obtain the server access information from the IC card information. In this case, it is no longer necessary to maintain the server access information on the device 20.

2-2. In the above embodiment, the controller 21 of device 20 starts the user communication handling process shown in FIGS. 3A-3B in response to receipt of the IC card information. However, the controller 21 may be configured to start the user communication handling process at any timing after receiving the IC card information, regardless of the timing at which the IC card information was received.

2-3. The controller 11 of the management device 10 may transmit location information (e.g., URL) indicating the location of the distribution file in S420, instead of transmitting the distribution file. In this case, the client device 40 may obtain the distribution file by accessing the location indicated by the location information.

2-4. The management unit 10 may be configured to transmit, in addition to the response, registration-related information registered in the user list database (see FIG. 2A) to the device 20 in S430. The registration-related information transmitted here may, for example, include at least information (e.g., IC card ID) that can identify the user. Then, the device 20 may be configured to store some or all of the registration-related information transmitted from the management device 10 in S200 as authenticated user information or as part of the authenticated user information.

In this way, by storing unique registration-related information associated with the user on the device 20 side, it is possible to efficiently perform subsequent processes on the device 20 based on the registration-related information. For example, by including information indicating that color printing is not permitted as registration-related information, it is possible for the device 20 to reject color printing when the corresponding user requests the device 20 for the color printing.

2-5. In the above embodiment, the management device 10 obtains the destination address of the distribution file by referring to the user list database (FIG. 2A), but the destination address of the distribution file may be obtained by any means. For example, user address information may be stored in the device 20, and the user address information may be transmitted together with the request data to the management device 10. Alternatively, for example, the user address information may be included in the IC card information obtained from the IC card 50. Then, the user address information contained in the IC card information may be transmitted from the device 20 to the management device 10 together with the request data.

2-6. The portable communication device according to the present disclosure may be in a different form from the IC card 50 of the above embodiment. For example, the portable communication device according to the present disclosure may be one that is easily portable, such as a smartphone or tablet-type device.

2-7. In the above embodiment, the IC card 50 and the device 20 are configured to communicate with each other using the NFC communication method, but the communication between the IC card 50 and device 20 may be performed using any communication method. For example, the communication may be performed using any of various communication methods such as BLE (Bluetooth Low Energy), Wi-Fi, Wi-Fi Direct, USB (Universal Serial Bus), a wired LAN, and the like. It is noted that “Bluetooth” is a registered trademark of Bluetooth SIG, and “Wi-Fi” is a registered trademark of Wi-Fi Alliance.

2-8. Multiple functions of one component in the above embodiment may be realized by multiple components, or one function of one component may be realized by multiple components. Further, multiple functions of multiple components may be realized by a single component, or a single function realized by multiple components may be realized by a single component. In addition, some of the components of the above embodiments may be omitted. Also, at least a part of the configuration of the above embodiments may be added or substituted for other configurations of the above embodiments.

What is claimed is:

1. A management system comprising a device and a management device,
wherein the device comprises:
a first communication interface configured to communicate with a portable communication device, the management device and an information processing device; and
a first controller,
wherein the first controller is configured to perform:
first receiving of user information for identifying a user from the portable communication device through the first communication interface; and
first transmitting of the user information received in the first receiving and device information for identifying the device to the management device through the first communication interface,
wherein the management device comprises:
a second communication interface configured to communicate with the device and the information processing device; and
a second controller,
wherein the second controller is configured to perform:
second receiving of the user information and the device information transmitted in the first transmitting through the second communication interface; and
second transmitting of one of device-related data and location information to the information processing device corresponding to the user information received in the second receiving, the device-related data including data used to control, from the information processing device, the device indicated by the device information received in the second receiving, the location information indicating a location of the device-related data.

2. A device comprising:
a communication interface configured to communicate with a portable communication device, a management device, and an information processing device, the management device being configured to transmit one of device-related data and location information to the information processing device corresponding to the user information in response to obtaining user information for identifying a user and device information for identifying the device, the device-related data including data to be used to control the device from the information processing device, the location information indicating a location of the device-related data; and
a controller,
wherein the controller is configured to perform:
receiving of user information for identifying a user from the portable communication device through the communication interface; and
transmitting of the user information received in the receiving and device information for identifying the device to the management device through the communication interface.

3. The device according to claim 2,
wherein the controller is further configured to perform obtaining of access information for accessing the management device, and
wherein the transmitting includes transmitting of the user information and the device information to the management device based on the access information obtained in the obtaining.

4. The device according to claim 3,
wherein the obtaining includes obtaining the access information received from the portable communication device through the communication interface.

5. The device according to claim 3,
further comprising a storage in which the access information is stored,
wherein the obtaining includes obtaining of the access information stored in the storage.

6. The device according to claim 2,
wherein the controller is further configured to perform the transmitting in response to receipt of the user information in the receiving.

7. The device according to claim 2,
further comprising a storage,
wherein the controller is further configured to perform storing the user information transmitted in the transmitting in the storage.

8. The device according to claim 2,
wherein the management device is configured to perform:
in response to receipt of the user information and the device information, transmitting registration-related information based on the user information as received to the device,
wherein the device further comprises a storage, and
wherein the controller is further configured to perform:
in response to receipt of the registration-related information through the communication interface, storing the received registration-related information in the storage.

9. The device according to claim 7,
wherein the controller is configured to perform avoiding execution of the transmitting when the user information received in the receiving is stored in the storage.

10. The device according to claim 7,
wherein the controller is configured to perform the transmitting when the user information received in the receiving is not stored in the storage.

11. A device management method employed in a management system including a device and a management device,
wherein the method comprising:
causing the device to receive user information for identifying a user from a portable communication device;
causing the device to transmit, to the management device, the user information received from the portable communication device and device information for identifying the device;
causing the management device to receive the user information and the device information transmitted from the device; and
causing the management device to transmit one of device-related data and location information to an information processing device corresponding to the user information received from the device, the device-related data including data used to control, from the information processing device, the device indicated by the device information, the location information indicating a location of the device-related data.

12. A controlling method used in a device configured to communicate with a portable communication device, a management device and an information processing device,
wherein the management device is configured to perform:
in response to obtaining user information for identifying a user and device information for identifying the device, transmitting of one of device-related data and location information to the information processing device corresponding to the user information, the device-related information including data to be used to control the device from the information processing device, the location information indicating a location of the device-related data, and
wherein the controlling method comprises:
receiving of the user information from the portable communication device; and
transmitting of the user information received from the portable communication device and the device information to the management device.

13. A non-transitory computer-readable recording medium for a device having a communication interface configured to communicate with a portable communication device, a management device and a controller,
the management device is configured to perform:
in response to obtaining user information for identifying a user and device information for identifying the device, transmitting one of device-related data and location information to the information processing device corresponding to the user information, the device-related information including data used to control the device from the information processing device, the location information indicating a location of the device-related data, and
wherein the non-transitory computer-readable recording medium containing computer-executable instructions which cause, when executed by the controller, the device to perform:
receiving the user information from the portable communication device; and
transmitting the user information received from the portable communication device and the device information to the management device.

14. A non-transitory computer-readable recording medium for a management device having a communication interface configured to communicate with a device and an information processing device, and a controller, the non-transitory computer-readable recording medium containing computer-executable instructions which cause, when executed by the controller, the management device to perform:
receiving user information for identifying a user and device information for identifying the device which are transmitted from the device through the communication interface; and
transmitting one of device-related data and location information to the information processing device corresponding to the user information received in the receiving through the communication interface, the device-related data including data used to control, from the information processing device, the device indicated by the device information received, the location information indicating a location of the device-related data.
